(19) United States
(12) Patent Application Publication
(10) Pub. No.: US 2008/0152849 A1
(43) Pub. Date: Jun. 26, 2008

(54) Insulating Glass Pane Comprising a Frame-Shaped Spacer

(76) Inventor: Karl Lenhardt, Bad Liebenzell (DE)

Correspondence Address: Orum & Roth, 53 West Jackson Boulevard, Chicago, IL, 60604-3606, US

(21) Appl. No.: 11/795,680

(22) PCT Filed: Aug. 2, 2005
(86) PCT No.: PCT/EP05/08357

§ 371 Date: Jul. 18, 2007

(30) Foreign Application Priority Data
Jan. 18, 2005 (DE) 10 2005 002 284.7

(51) Int. Cl. E06B 3/667

(52) U.S. Cl. 428/34

(57) ABSTRACT

The invention relates to an insulating glass panes, in which two separate glass panes (45, 46) are held at a distance from one another by a frame-shaped spacer which is formed from a hollow profile rod (1) or hollow profile rod which are connected in a linear manner. Said spacer comprises an outer (2), two flanks (3,4) and an inner wall (5), with at least one corner (31-34) whereon the hollow profile rod (1) has a recess which starts from the inner wall (5) and extends into the flanks (3,4) in the direction of the outer wall (2) without opening the outer wall (2). According to the invention, a pre-fabricated angle piece (13) is arranged in the hollow profile rod (1) on the at least one corner (31-34) of the spacer and has two limbs (14,15) which are connected by an articulated joint (16) and which are secured in relation to each in one position wherein it forms a predetermined angle.

The invention relates to an insulating glass pane having the features specified in the preamble of claim 1. Such an insulating glass pane has been known for example from U.S. Pat. No. 5,439,716 A. In the case of the known insulating glass pane, two separate glass panels are held at a distance by a thin-walled spacer formed from a hollow profile rod made from metal that comprises an inner wall, an outer wall and two flanks. The hollow space of the spacer contains a granular drying agent that is packed, at least at the corners of the spacer, tightly enough to be capable of transmitting pressure from the one flank to the other flank. The drying agent, for example zeolite, serves the function to absorb and bind humidity that may be present in the inner space of the insulating glass pane in order to prevent the conditions in the inner space of the insulating glass pane from falling below the dew point as the pane cools down. The inner side of the spacer is perforated for this purpose so that the humidity can migrate from the inner space of the insulating glass pane into the hollow space of the spacer for being absorbed. In order to prevent humidity from penetrating from the outside into the inner space of the insulating glass pane, a gap is provided between the flanks of the spacer and the two glass panels, which gap is sealed by a sealing compound that adheres to the spacer and to the glass panels. The sealing most commonly used is a polyisobutylene (butyl caoutchouc) by which adequate sealing from diffusion of water vapor can be achieved.

Polyisobutylenes are thermoplastic, adhesive substances. In addition to their function of sealing the inner space of the insulating glass pane, they further serve, during assembly of the insulating glass pane, to provide a temporary bond between the spacer and the two glass panels to which the spacer is bonded along the panel edges. As polyisobutylenes are thermoplastic materials they are, however, not suited for producing a durable, firm mechanical bond between the glass panels of the insulating glass pane. Rather, that bond is produced in the known insulating glass panes by a curable sealing compound or bonding compound which is applied to the spacer between the glass panels either to cover the entire outside of the spacer, extending without any interruption from the one glass panel to the other glass panel, or by forming two ropes of the secondary sealing compound, one bonding one of the glass panels to the spacer and the other one bonding the other glass panel to the spacer, in which case the outside of the spacer may remain uncovered in full or in part. Commonly used as secondary sealing compounds are curable two-component plastic materials, especially polysulfides, polyurethanes and silicones.

Spacers for insulating glass panes mostly consist of hollow profile rods made from aluminum or stainless steel that contain a bulk drying agent, normally molecular sieves. The drying agent serves the function to bind humidity present in the insulating glass pane so as to ensure that the conditions will not fall below the dew point at the temperatures occurring in the insulating glass pane. Today, metallic spacers are mostly bent as a single piece from a hollow profile rod. Following the bending operation, the two opposite ends of the hollow profile rod are joined using a connector element so as to form a closed frame. As a rule, the hollow profile rods to be bent are connected one with the other in series using connector elements. Accordingly, the spacers may also comprise more than one connector elements. Such frame-shaped metallic spacers distinguish themselves by good mechanical stability. However, they are connected with the disadvantage that they form a thermal bridge between the different glass panels of the insulating glass pane.

In order to reduce the effect of the thermal bridge, it has been known to use spacer frames made from metallic U-sections, from thermoplastic solid profiles that are extruded directly onto a glass panel, and from hollow plastic sections which, just as spacers made from metallic hollow profile rods, are filled with a granular, bulk drying agent.

Spacers made from hollow plastic sections have low thermal conductivity thereby hindering heat transfer between the different glass panels of an insulating glass pane in a desirably way. However, it is a disadvantage that if hollow profile rods made from plastic materials have the hardness and strength required for use as spacers for insulating glass panes they cannot be bent into angular frames. This especially applies to hollow profile rods made from fiber-reinforced plastic materials. Now, one might imagine to form spacer frames from hollow profile rods by connecting straight hollow profile sections, forming the sides of the frame-shaped spacers by fitting metal angle pieces in the ends of the hollow profile rods where they are captivated by barbs provided on them. That technique, which has been known in the past for producing metallic spacers, is however laborious and results in spacer frames which, due to the lack of rigidity in the corner area, are altogether instable and cannot be handled easily and be bonded on a glass panel with the necessary precision. Further, spacer frames having such connector-joined corners are unfavorable if one considers that the edges of an insulating glass pane must be hermetically sealed from penetrating humidity. In addition, their metallic angle pieces produce undesirable thermal bridges at the corners of the spacer.

Further, it has been known to form spacers from metallic hollow profile rods by connecting separate hollow profile rods at the corners of a spacer by angle pieces comprising two legs, connected by a joint, which can be locked one relative to the other in a position in which the legs enclose between them a right angle. To this end, the separate hollow profile rods are initially connected one to the other in linear fashion, are provided with an adhesive sealing compound applied continuously onto their flanks and are then formed into a frame by pivoting the hollow profile rods about the joint of the respective angle piece, whereafter the frame is closed by a linear connector fitted in the ends of the hollow profile rod. Such a configuration of the corners results in instable spacers provided with the disadvantages described above.

In order to produce spacers from hollow profile rods in a single piece, it has been known from EP 0 947 659 A2 and from EP 1 030,024 A2 to notch the hollow profile rods at the points where corners are to be formed, by producing V-shaped cuts the points of which extend up to the wall of the hollow profile rod that forms the outer wall in the finished spacer. For forming a frame, only the outer wall of the hollow profile rod then has to be bent at the notched point. One thereby obtains spacers that have a closed outer wall even at the corners, but as the legs of the spacer are connected one with the other at the corners by their outer wall only, the frame altogether is an instable structure that needs to be stabilized. For this purpose, it has been known from EP 0 947 659 A2 and from EP 1 030 024 A2 to inject a thermoplastic material into the corner area of the spacer frame through an opening in one of its flanks, which plastic material will then bridge the corners and impart to the spacer the required stability once the material has cooled down and cured. It is, however, a disadvantage that it takes comparatively long time until the plastic material has cooled down and cured. In order to shorten that time, it has been known from EP 1 030 024 A2 to transfer the spacer being produced, after injection of the plastic material, to a separate curing zone while maintaining the angle of the corner that has been bent before. That way of proceeding is time-consuming and costly.

Now, it is the object of the present invention to provide a way how to design and produce insulating glass panes at low cost without sacrifices in quality and sealing of the mechanical coherence of the insulating glass pane. Further, the result is to be suited for the production of large quantities of standardized insulating glass panes.

The invention further is to be suited for the use of spacers produced from hollow profile rods made from a plastic material.

That object is achieved by an insulating glass pane having the features defined in claim 1. Advantageous further developments of the invention are specified in the sub-claims.

Insulating glass panes according to the invention comprise spacers having at least one corner that are formed from hollow profile rods. A spacer, having a single corner only, may be used for example in what is known as model panes, i.e. panes the contour of which differs from the usual rectangular shape. A spacer with a single corner only may have two continuously formed legs, that start out from the corner, extend along a curved shaped and joint each other by their ends. A spacer having two corners may have the shape of an archway, for example. A spacer having three corners may comprise a curved section, or may be formed from straight legs that form an equal-sided or equal-angle or any other triangle. In the preferred case of right-angle corners, the spacer generally has four corners. At each of the corners, the hollow profile rod has a recess, beginning at the inner wall and extending into the flanks in the direction of the outer wall, without opening or piercing the outer wall. At each of the corners of the spacer according to the invention, a prefabricated angle piece is placed in the hollow profile rod, which comprises two legs that are connected by a hinge and that are fixed in relation to each other in a position in which they enclose between them the predefined angle different from 180 degrees, preferably a right angle.

That arrangement provides substantial advantages for an insulating glass pane:
The spacer has a continuous outer wall also in the area of its corners, which stabilizes the shape of the spacer and has a favorable effect on the sealing of the insulating glass pane.
Formation of folds in the flanks can be prevented at the corners by the envisaged recesses.
By fitting a prefabricated angle piece the corners are reliably stabilized.
The angle pieces can be fitted in the hollow profile rod as long as the latter is still in its straight configuration. The recesses provided in the profile rod at the points where the corners are to be formed make it possible to insert the angle piece in the hollow profile rod while the two legs of the angle piece are not yet fixed in the predefined angular position, especially at a right angle one relative to the other. After introduction of the angle piece, the latter, just as the hollow profile rod as such, initially occupies a straight configuration. The corners can then be formed simply by folding the hollow profile rod and the angle pieces fitted in it. In doing so, the legs of the angle piece are fixed in a position in which they enclose between them the predefined angle. They thereby fix the legs of the folded hollow profile rod, that joint each other at a corner, at the predefined angle one relative to the other. Once all corners of the spacer have been formed, the two ends of the hollow profile rod are arranged one opposite the other and can be connected by a conventional linear connector which is fitted in the two ends of the hollow profile rod.
The spacer can then immediately be handled as a stable structure, as contrary to the prior art known from EP 947 659 A2 or EP 1 030 024 A2, where the corners of the spacer frame are stabilized only after curing of a plastic material, that has been injected into the corner areas, the angle pieces fitted according to the invention will develop their stabilizing effect immediately.
However, there is also the possibility to let the ends of the hollow profile rod joint each other at one or more corners of the spacer and to connect the ends at that corner by a prefabricated rigid angle piece. The lower stability of that one corner can then be compensated in part by the higher stability of the other corners. It is, however, advisable to seal the joint between the angle piece and the ends of the hollow profile rod at that corner with particular care.
The invention is suited for thin-walled hollow profile rods made from metal. The combination of a foldable angle piece with a continuous outer wall at the corners of the hollow profile rod leads to corners that are substantially more stable than corners obtained by merely assembling separate hollow profile rods with the aid of rigid angle pieces.
The invention permits the production of spacers with bent corners with a minimum bending radius, which provides optimum utilization of the glass panels in terms of light transmission.
The invention is the first to allow the production of insulating glass panes having spacers with corners in which angle pieces are fitted and which still do not have a marginal joint on the outside of the spacer that must be filled with a sealing compound.
The invention is particularly well suited for spacers made from thin-walled hollow plastic profile rods. Due to the combination of a foldable angle piece with a continuous outer wall at the corners of the hollow profile rod such spacers are stabilized more efficiently, more quickly and at lower cost than spacers made from plastic hollow profile rods where the corners are stabilized by injection of a plastic material.

The legs of the angle piece can be fixed in different ways one relative to the other at the predefined angle, especially at a right angle. One way of achieving this consists in fixing the predefined angle of the two legs of the angle piece one relative to the other by a fitting piece that can be introduced only in the predefined angular position of the legs one relative to the other. The fitting piece may consist of a wedge or a pin, for example.

A different way of fixing the two legs of the angle piece at the predefined angle one relative to the other consists in making the hinge resilient by having the two legs of the angle piece bent off under the action of a spring until they come to abut each other in the predefined angular position.

Preferably, the angle piece is designed so that the two legs are locked or snap-fastened one relative to the other in the position in which they enclose between them the predefined angle, being thereby connected in form-locking engagement. That locking or snap-fastening or form-locking engagement is intended to secure the predefined angular position of the two legs one relative to the other.

To this end, a recess may be provided on the one leg of the angle piece for form-locking engagement in a projection provided on the other leg of the angle piece when the predefined angle is enclosed between the two legs. For reasons of symmetry and safety of the connection between the two legs it is preferred in this connection if a projection as well as a recess are provided one beside the other on both legs for reciprocal engagement.

The two legs of the angle piece can be connected one with the other in different ways. They may be connected in the way of a hinge, to pivot about a common bolt or pin. Preferably, however, the two legs of the angle piece are combined to a single piece, and the hinge between them is configured in the way of a foil hinge. Such an angle piece can then be produced as a molded part from a plastic material, at especially low cost.

Preferably, the joint is arranged on the outside of the angle piece that faces the outer wall of the hollow profile rod. When bending the corner, the bending axis therefore extends close to the outer wall of the hollow profile rod so that the bending axis is subjected to moderate strain only. Further, the outer wall of the hollow profile rod is supported by the hinge during bending of the respective corner. Finally, with the pivoting axis in that position, the recess provided in the hollow profile rod is closed again to the greatest possible extent not only at the corners, but in part also at the inner wall.

The recess in the hollow profile rod extends in the flanks preferably up to the outer wall and its shape in the flanks preferably is that of a 90° miter cut, for right-angle corners.

The angle pieces preferably are configured so that their legs can be pivoted from a flat position of the angle piece not only to their position in which they enclose between them the predefined angle at which they can be fixed one relative to the other, but also in opposite direction. This provides an elegant way of fitting the angle pieces in a hollow profile rod: One pivots the legs in opposite direction until their free ends can be introduced simultaneously into the hollow profile rod through the recess in its inner wall. By pressing on the hinge it is possible to transfer the angle piece to its straight configuration during which process its two legs will slide below the inner wall and into the hollow space of the hollow profile rod. Stops arranged on the legs of the angle piece, and directed toward the edges of the recess in the inner wall that extend from the one flank to the other flank, may be used to center the angle piece in the recess in which position both stops will be in contact with the edges of the inner wall of the hollow profile rod, extending transversely to the longitudinal direction of the hollow profile rod, the spacing between those edges being adapted to the spacing of the stops. Conveniently, the two stops are equally spaced from the axis of the hinge.

Another approach of fitting the angle piece in a recess in the hollow profile rod consists in pushing the one leg of the angle piece through the recess and into the hollow profile rod through the recess in the inner wall until the other leg can be fitted in the hollow profile rod in straight configuration. One then displaces the straight angle piece until it assumes the centered position it should occupy for bending of the corner and in which both ends of the angle piece, still in its straight configuration, extend in the hollow space of the hollow profile rod because the straight angle piece is longer than the recess in the hollow profile rod through which the angle piece has been introduced into the hollow profile rod. The position which the angle piece is to assume for the process of bending the corner may again be determined by a stop which is provided on one of the legs and which comes to abut against the edge of the hollow profile rod as the straight angle piece is displaced in the hollow profile rod. In this case, too, a further stop may be provided on the other leg, for abutment between the angle piece and the opposite edge of the recess, as the angle piece is introduced into the hollow profile rod. However, that stop will then be positioned closer to the hinge.

An insulating glass pane must be sealed against diffusion of humidity. It therefore has been known to apply a sealing compound on the flanks of the spacer formed from a hollow profile rod, for preventing diffusion of water vapor. A sealing compound based on polyisobutylene, a permanently elastic butyl caoutchouc, has proven its value for that application. According to an advantageous further development of the invention, the spacer according to the invention is continuously coated on its inner side with such a sealing compound, for example one based on polyisobutylene. This provides considerable advantages:
The sealing compound not only closes the inner space of the insulating glass pane against penetration of humidity, but also seals the recess in the inner wall of the spacer so that it is no longer visible in the finished insulating glass pane. The spacer coated with the sealing compound has a uniform, esthetically attractive appearance in the insulating glass pane.
There is no need for filling a drying agent, intended to bind humidity that may be present in the inner space of the insulating glass pane, into the hollow spacer by a separate operation; rather, the drying agent may be integrated in the sealing compound and may be applied to the inner wall of the spacer together with the compound. Suited as drying agents are molecular sieves (zeolites) in powder form.
The hollow profile rods used may be low-cost profile rods which as such are not capable of preventing diffusion of water vapor to the inside, as any water vapor that may overcome the hollow profile rod will be finally absorbed by the sealing compound and, if necessary, bound by the drying agent contained in the latter. The invention therefore is particularly well suited for spacers made from thin-walled hollow plastic profile rods.
Contrary to the prior art, the outer wall of the spacer no longer needs to be sealed, and this even in cases where the hollow profile rod as such cannot prevent diffusion of water vapor. According to the invention, there is no need for a marginal joint of the kind found in conventional insulating glass panes for sealing purposes. Rather, the outer wall of the spacer may end flush with the edges of the glass panels of the insulating glass pane.
As there is no marginal joint that has to be sealed in the insulating glass panes, an insulating glass pane using a spacer according to the invention can be handled immediately after assembly, and can also be touched in the marginal area and processed further, for example installed in prefabricated window frames. There is no need to wait until a sealing compound in a marginal joint has cured.
Due to the fact that the sealing compound is applied on the spacer so as to cover the entire inner wall of the spacer, it is possible to apply a curing sealing or bonding compound, that produces a durable firm bond between the spacer and the two glass panels of the insulating glass pane, exclusively on the two flanks of the hollow profile rod. It is not necessary to provide a marginal joint in the insulating glass pane, on the outside of the spacer, for the purpose of receiving a curable sealing compound consisting, for example, of the commonly used polysulfides (thiocol) and polyurethane.
A coating thickness of 2 mm to 4 mm will be sufficient for the sealing compound applied on the inner wall of the spacer.
The quality demands placed on hollow profile rods from which spacers are made may be lowered because the hollow profile rods have to fulfill a mechanical task only, namely the task to keep the glass panels of the insulating glass pane at their predefined distance under their typical conditions of use and typical strains, and to combine with a sealing compound and/or with a curable sealing or bonding compound. It is thus possible to use extremely low-cost and thin-walled hollow profile rods that can be optimized for minimum heat transfer. Any untightness of the profile rods will not lead to untightness of the insulating glass pane.
Especially in cases where the spacer is made from a plastic material, extraordinarily low heat transfer coefficients are obtained in the area of the spacer.
Sealing compounds based on polyisobutylenes generally have a matt black surface. That surface will adapt itself at any time to the appearance of the particular color of the window frame, reflecting the latter's shade.
The hollow profile rod may be coated with the sealing compound on its inner side and, preferably, also over an adjacent portion of its flanks before it is bent into a frame-like spacer. This not only permits a very rational linear process with a minimum of mechanical input, but simultaneously provides especially efficient sealing of the corners of the spacer into which part of the sealing compound is pressed during folding of the corners.
A curable bonding compound or sealing compound, which preferably is applied on the flanks of the hollow profile rods, may likewise be applied with advantage before the hollow profile rod is formed into the frame-shaped spacer. Especially a reactive hot-melt bonding compound is particularly well suited for use as a bonding compound or sealing compound in such a process.
The bonding compound or sealing compound applied on the flanks accumulates in the corners of the flanks during folding, is compressed as the insulating glass pane is pressed together and is pressed into the corner of the spacer thereby supporting the formation of tight corners without any separate measures or costs being required for that purpose.
All in all, the invention provides a very low-cost and high-quality production process for insulating glass panes and is well suited also and especially for rational production of large quantities of insulating glass panes in standardized dimensions.

Preferably, the sealing compound is applied on the inner side of the profile rod in a width such that the compound will project over, and will in part cover, the flanks. This provides the advantage that during subsequent assembly of the insulating glass pane the sealing compound will be compressed between the two glass panels, which favors the production of a tight bond between the two glass panels.

The sealing compound and the curable bonding compound or secondary sealing compound should joint each other without any gaps at the flanks. Instead of using the sealing compound and a separate bonding compound or curable secondary sealing compound, it is also possible to use a uniform or common sealing and bonding compound that provides both the desired safety from diffusion of water vapor into the insulating glass pane and a durable firm bond between the spacer and the glass panels of the insulating glass pane. The common sealing and bonding compound may, for example, consist of a reactive hot-melt which is applied in hot condition and which cures reactively after assembly of the insulating glass pane. If a common bonding and sealing compound is used, it preferably also contains a drying agent in powder form.

Spacers according to the invention are well suited for installation of one or more muntins. Preferably, the muntins are fitted in such a way that they are anchored directly or indirectly in the sealing compound on the inner side of the spacer. As the muntins are thin-walled and hollow, the forces that have to be taken up by the sealing compound for holding the muntins are only small.

Preferably, the muntins are connected with separate foot pieces, which are directly anchored in the sealing compound in form-locking engagement. The foot pieces preferably have a foot plate and a connection means that projects from the latter and by means of which the foot piece and the muntin are connected. The foot plate can be pressed into the sealing compound, without piercing it, thereby maintaining the sealing effect of the compound. It is fixed in ing it, thereby maintaining the sealing effect of the compound. It is fixed in its position in part by its engagement with the sealing compound and in part by the bonding effect of the sealing compound. Especially well suited as a foot plate is one with recesses and/or passages because these are capable of accommodating any displaced sealing compound whereby sort of an interlinking can be produced between the foot plate and the sealing compound.

Only a single foot piece will be required for all possible sorts of muntins if, instead of being directly fitted in the hollow end of the different muntins, the foot piece is directly connected with an adapter which in turn is fitted in the prefabricated muntin. The adapter is adapted to the particular cross-section on the one side and to the shape of the foot piece on the other side, and that adaptation to the shape of the foot piece may be identical for all adapters required for the different muntin cross-sections. For mounting the muntins on the frame-shaped spacer or on a profile rod, from which the frame-shaped spacer is formed, one therefore only needs a single kind of foot piece, a single magazine for the storekeeping of foot pieces, and only a single tool for positioning the foot pieces on the spacer or on the profile rod from which the spacer is formed. Consequently, such foot pieces can be mounted on the spacer in an especially rational way.

The sealing compound used, containing the drying agent, may be a material from which the thermoplastic spacer is formed in TPS® insulating glass panes. That material is based on a polyisobutylene and is well suited also for purposes of the invention. It may also be used between the glass panels of the insulating glass pane and the flanks of the spacer, instead of a sealing compound containing no drying agent. Another advantageous solution is obtained, for example, if a polyisobutylene is used as basis for the sealing compound containing a drying agent, and if the drying agent is concentrated in the sealing compound that faces the inner space of the insulating glass pane, while the sealing compound applied on the flanks of the spacer contains only little or absolutely no drying agent.

The sealing compound containing a drying agent is applied on the inner side of the spacer over a width greater than the width of the spacer and preferably also covers the flanks so that it will be compressed, as the glass panels are pressed together, and come to adhere to the glass panels over a certain area. In order to produce such compression it is not necessary for the sealing compound containing a drying agent to adhere to the full surface of the inner side of the spacer. Preferably, the sealing compound is applied on the spacer, or on the hollow profile rod forming the spacer, in such a way that its inner side, facing the inner space of the insulating glass pane, and an additional stripe of the flanks will be covered. This guarantees that when the glass panels and the spacer are pressed together, the sealing compound will be subjected, at least in the area of the flanks, to sufficient pressure for bonding them without any gaps to the spacer flanks on the one side and to the glass panels on the other side. Thus, the sealing compound produces at least a temporary compound structure from the glass panels and the spacer. If necessary, the compound structure is completed by a curable sealing or bonding compound. The latter may extend without any interruption from the one glass panel over the outer wall of the spacer to the other glass panel. In order to produce the necessary permanent mechanical coherence, it will however be sufficient if the glass panels are connected only indirectly by the curable sealing or bonding compound. This can be achieved by applying the curable compound in the form of two separate ropes, one of them connecting the spacer with the one glass panel and the other one connecting the spacer with the other glass panel. This reduces the quantity of sealing compound consumed and also the heat transfer in the area of the spacer.

In cases where the flanks of the spacer are plane and the gap between the flanks and the glass panels is substantially filled by the sealing compound, a curable sealing or bonding compound may be provided in the angle between the outside of the spacer and the respective neighboring glass panel, and a surface especially in the form of a hollow groove may be provided in that area. According to an especially preferred solution, the curable sealing compound is provided only in the gap between the flanks of the spacer and the separate glass panels. This provides the advantage that the outside of the spacer can end flush with the edge of the glass panels whereby the useful light transmitting surface of the insulating glass pane is increased and the depth up to which the edge of an insulating glass pane is bordered in a window frame or a door frame, is reduced; this results in more delicate window and door frames. There is even the possibility to make the outer wall of the spacer project beyond both sides of the flanks of the spacer and to thereby cover the edge of the two glass panels by the projections so formed. One thereby readily obtains a solution where the glass edges are protected from splintering and the workmen who transport and install the insulating glass panes are protected from cuts. In the case of that advantageous further development of the invention, the secondary sealing compound preferably extends into a gap between the projections of the spacer and the edge of the glass panels.

In an insulating glass pane according to the invention, the curable sealing or bonding compound preferably is applied to directly adjoin the sealing compound. As the latter extends into the gap between the flanks of the spacer and the glass panels, and as that gap has a small width, compared with the spacing of the glass panels, and can be sized exclusively with a view to achieving reliable sealing, the surface over which the sealing compound and the curable sealing or bonding compound can brought into contact is only small, compared with the surface over which the sealing compound and the curable sealing compound of a TPS® insulating glass pane are in contact one with the other. Consequently, the degree in which incompatibility reactions may occur between the sealing compound and the curable sealing or bonding compound is only low.

The position of the sealing compound at its envisaged location can be additionally secured by interlocking the compound with the spacer by a suitable form-fit. This is the case in an advantageous further development of the invention. The form-fit between the sealing compound containing a drying agent and the spacer preferably exists at the transition from the inner wall to the flanks of the spacer. Advantageously, the form-fit is achieved by providing the flanks of the profile rod, or the spacer formed from it, by an undercut over their full length. The undercut, especially if designed as a dovetail, then forms an abutment which prevents the sealing compound on the flanks from evading the compression force. This is favorable with respect to sealing the gap between the spacer and the glass panels. Such an undercut design can be easily realized during production of the hollow profile rods by extrusion from metal or by extrusion from a plastic material and does not necessarily increase the cost of the hollow profile rod. A form-fit between the spacer and the sealing compound in the form of a dovetail connection is especially well suited. Mechanical interlocking with the spacer is added to the bonding effect of the sealing compound and guarantees a reliable bond with the spacer, even under the effect of high temperature variations.

Spacers formed from hollow plastic profile rods are especially preferred. They distinguish themselves by good mechanical stability, even when the wall thickness is only small. In the simplest of all cases, the hollow profile rod has a rectangular cross-section and the least possible height in order to keep the costs of materials and the heat transfer coefficient low. The minimum height is determined by the consideration that the necessary compressive strength and safety from tilting must be obtained for the legs of the spacer and that the sealing compound applied on the flanks of the hollow profile rod must present sufficient resistance to diffusion of water vapor into the insulating glass pane. Useful results are already obtained with a hollow profile rod 4 mm high.

Certain embodiments of the invention are illustrated in the attached drawings. Identical parts, or parts corresponding one to the other, are identified by the same reference numerals in the examples.

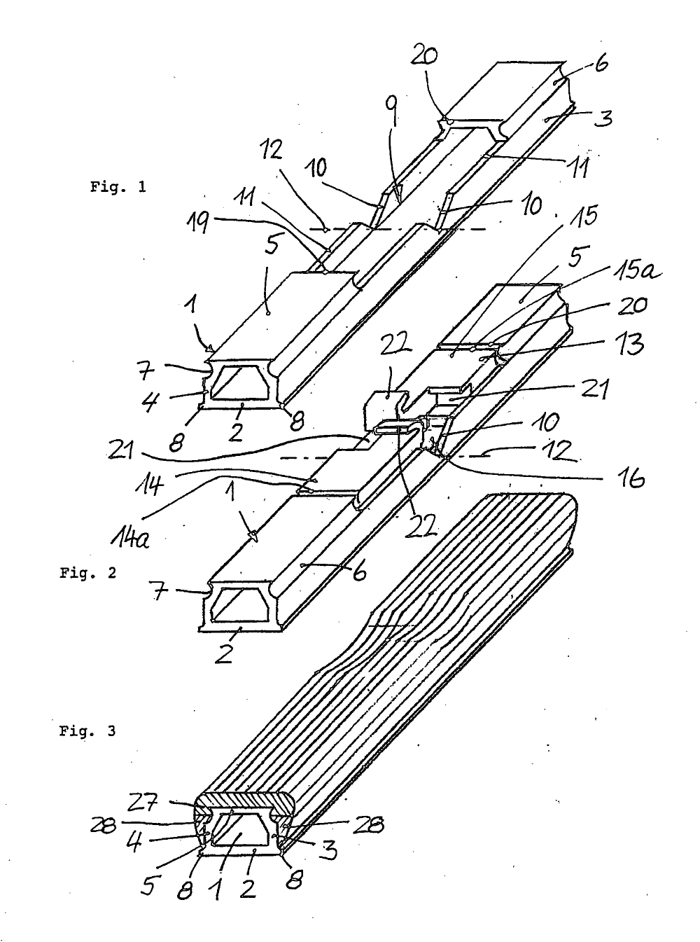

FIG. 1 shows an oblique view of a portion of a hollow profile rod that is provided with a recess for forming a right-angle corner;

FIG. 2 shows a view similar to that of FIG. 1 of a hollow profile rod after fitting of an angle piece, which is still in its straight configuration;

FIG. 3 shows an oblique view of the hollow profile rod of FIG. 2 after coating with a sealing compound and a bonding compound;

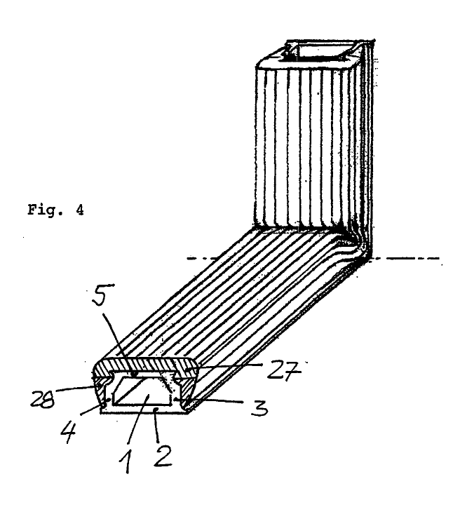

FIG. 4 shows the hollow profile rod of FIG. 3 after folding of a right-angle corner;

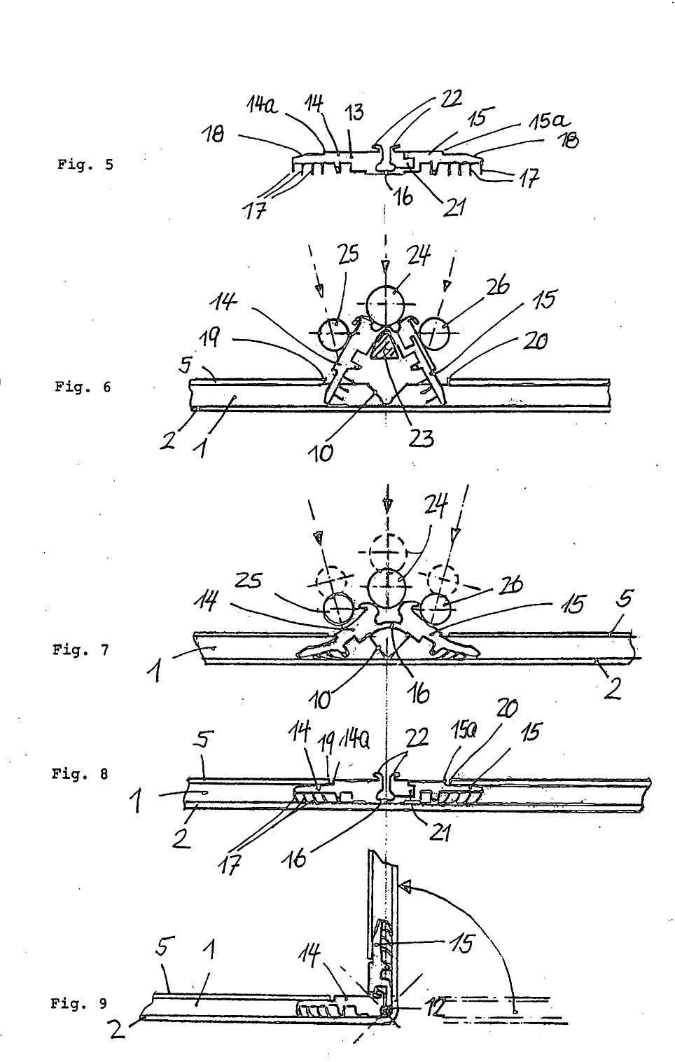

FIG. 5 shows a side view of the corner angle according to FIG. 2;

FIGS. 6 to 8 show, by way of a longitudinal section through a hollow profile rod, how the angle piece from FIG. 5 can be fitted in the hollow profile rod illustrated in FIG. 1;

FIG. 9 shows the formation of a corner in the hollow profile rod illustrated in FIG. 8;

FIG. 10 shows a side view of a modified angle piece;

FIGS. 11 to 13 shows a way in which the angle piece illustrated in FIG. 10 can be fitted in the hollow profile rod illustrated in FIG. 1;

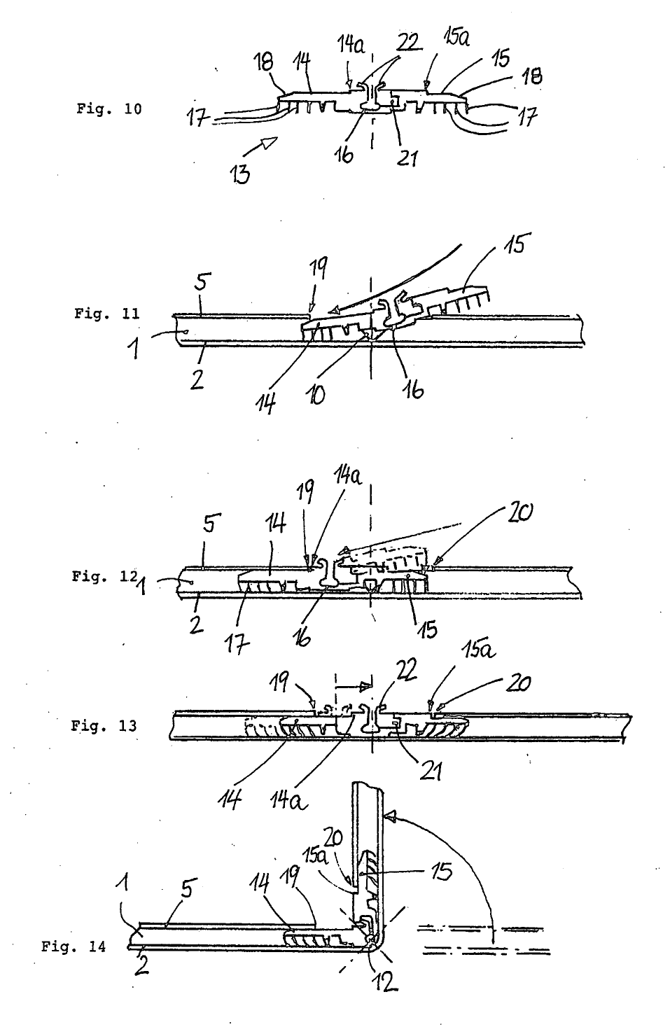

FIG. 14 shows the formation of a right-angle corner in the hollow profile rod illustrated in FIG. 13;

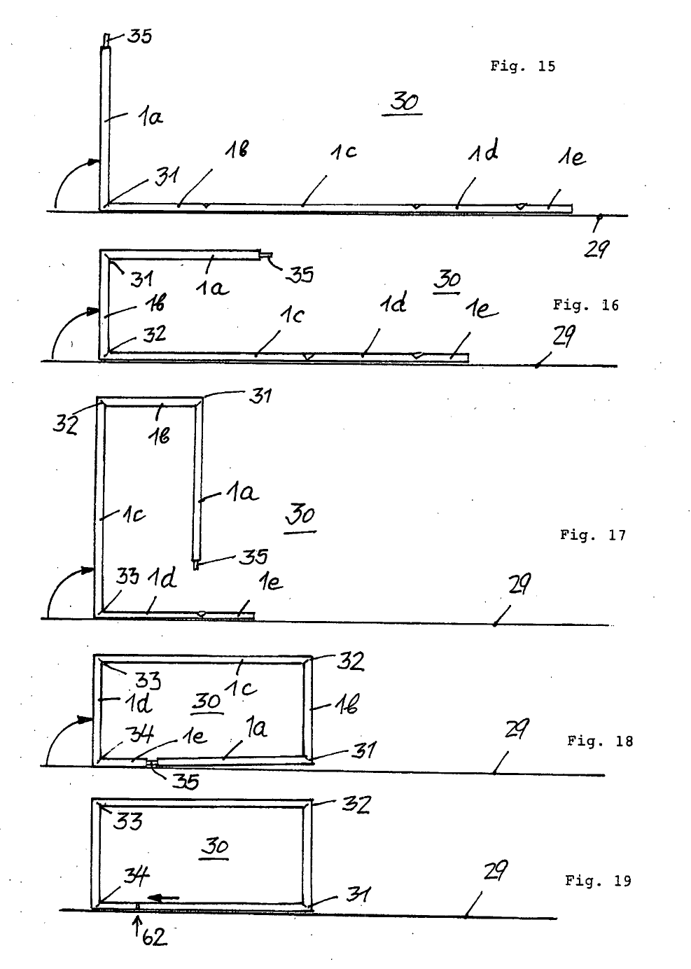

FIGS. 15 to 19 show in a diagrammatic representation how a closed frame-shaped rectangular spacer is formed by bending off a hollow profile rod at four points and connecting its ends one with the other;

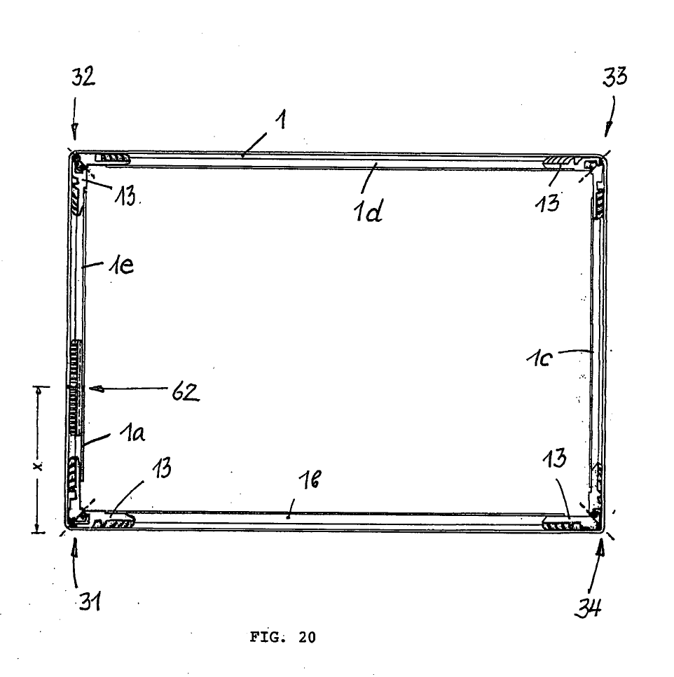

FIG. 20 shows, by way of a diagrammatic longitudinal section through the hollow profile rod, a frame-shaped spacer that has been formed using angle pieces according to FIGS. 10 to 14;

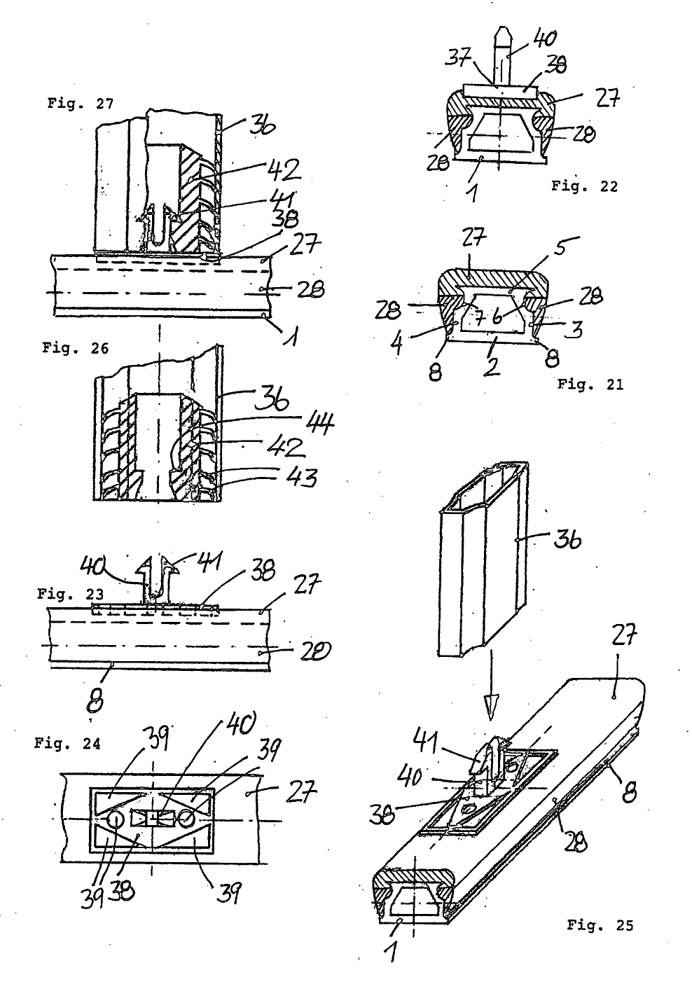

FIG. 21 shows a cross-section through a coated hollow profile rod according to FIG. 3;

FIG. 22 shows, in a representation similar to that of FIG. 21, the coated hollow profile rod with the angle piece for a muntin anchored thereon;

FIG. 23 shows a side view of that portion of the hollow profile rod on which a foot piece according to FIG. 22 is provided;

FIG. 24 shows a top view of the portion of the hollow profile rod that is provided with the foot piece according to FIG. 23;

FIG. 25 shows an oblique view of the portion of the hollow profile rod illustrated in FIG. 24 during delivery of a muntin;

FIG. 26 shows a longitudinal section through the lower end of the muntin according to FIG. 25;

FIG. 27 shows a longitudinal section through the lower end of the muntin according to FIG. 25, after fitting of the foot piece;

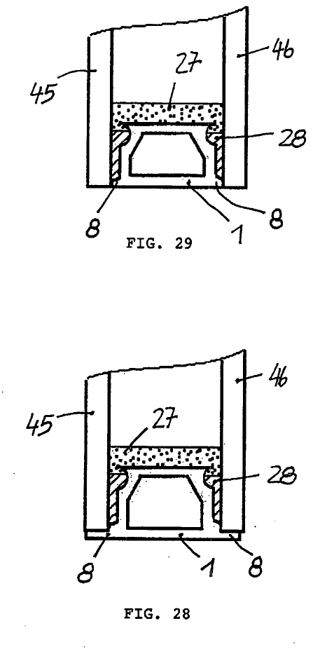

FIG. 28 shows a cross-section through a marginal portion of an insulating glass pane with a spacer according to FIG. 21;

FIG. 29 shows a modification of the example illustrated in FIG. 28;

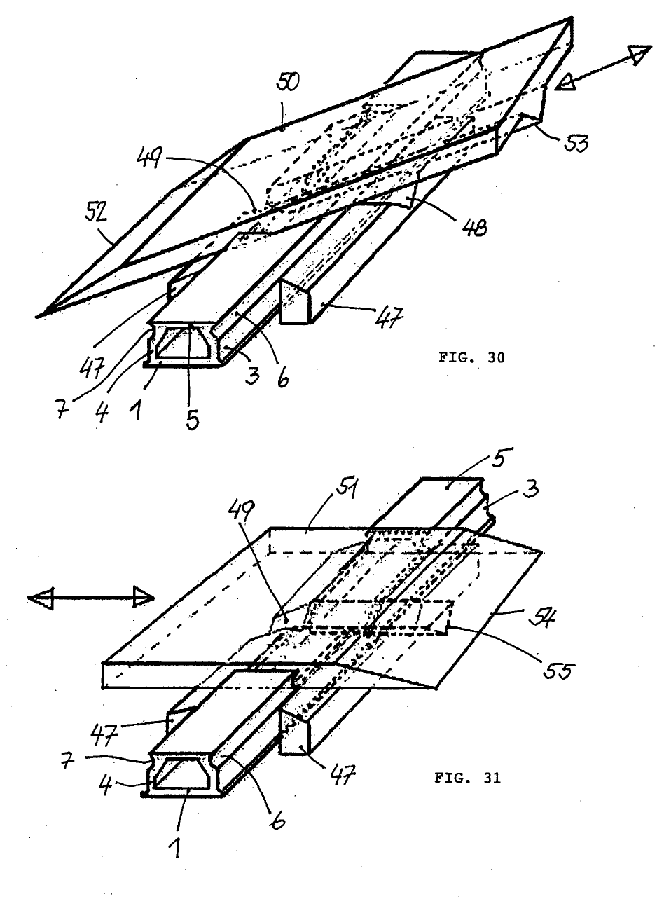

FIG. 30 shows by way of an oblique view a first step of forming a recess in a hollow profile rod according to FIG. 1;

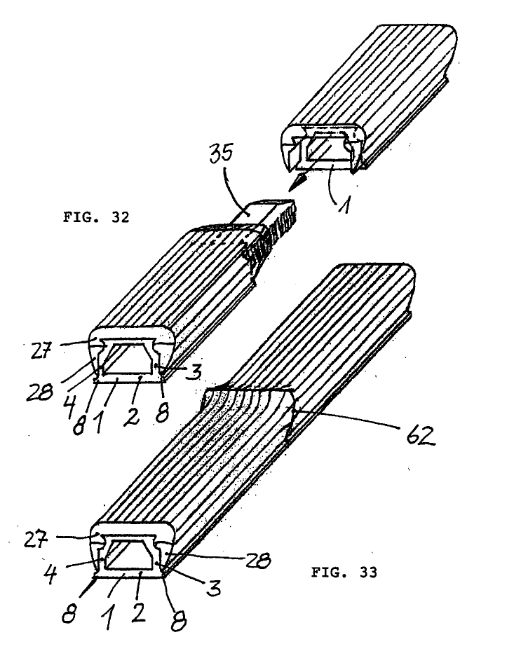

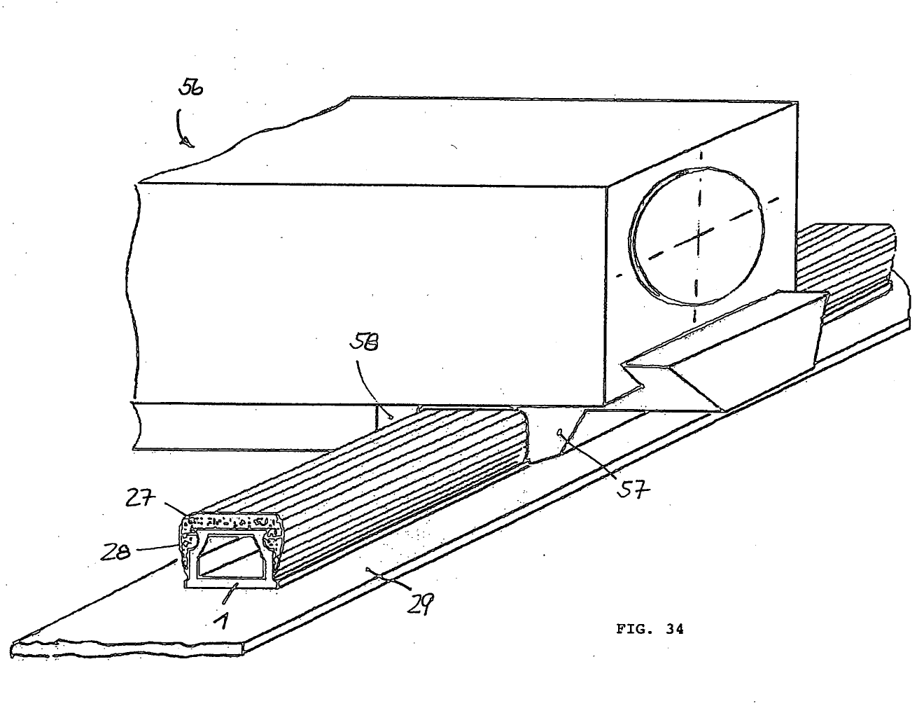

FIG. 31 shows by way of an oblique view a second step of forming a recess in a hollow profile rod according to FIG. 1;

FIG. 32 shows an oblique view of the two ends of a coated hollow profile rod, prior to connection of the ends and closing of the spacer;

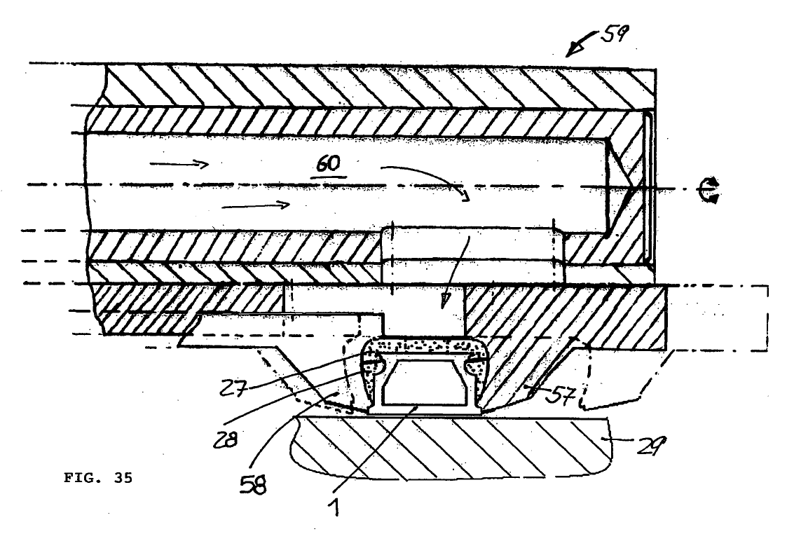

FIG. 33 shows the joint of the spacer after closing of the spacer;

FIG. 34 shows an oblique view of a tool for closing the joint from FIG. 33, at the moment the tool embraces the joint;

FIG. 35 shows by way of a cross-section through the hollow profile rod, a nozzle embracing the joint of the spacer for subsequent application of sealing compound onto the joint; and

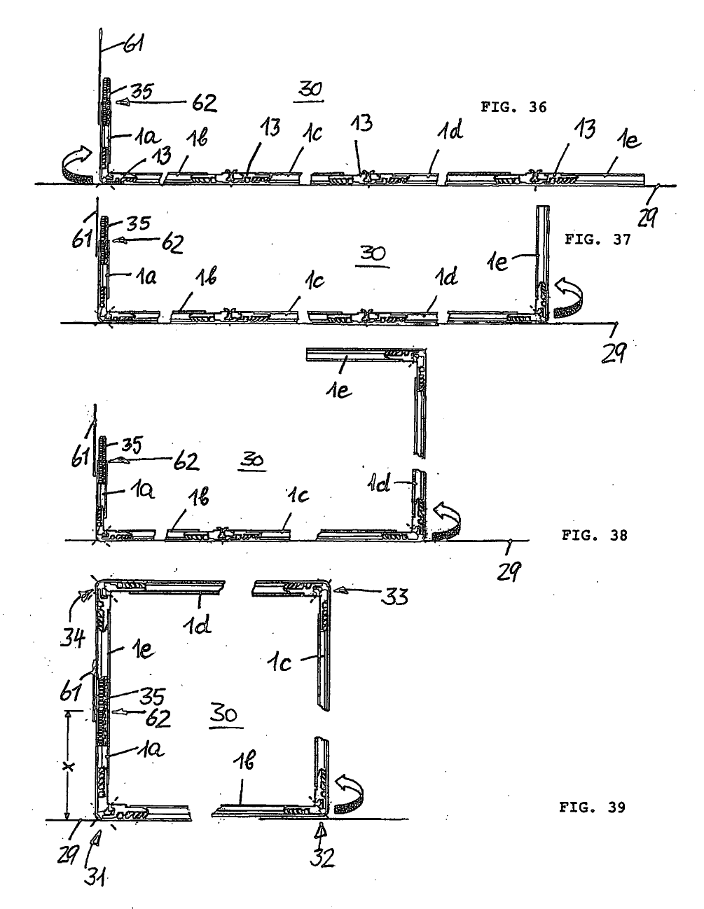

FIGS. 36 to 39 show a modified procedure, relative to that shown in FIGS. 15 to 19, of forming a closed, frame-shaped rectangular spacer by bending the hollow profile rod off at four points and connecting its ends one to the other; and

FIGS. 40 and 41 show modified configurations of a corner of the spacer, as a detail.

FIG. 1 shows a section of a hollow profile rod 1 having an outer wall 2, two flanks 3 and an inner wall 5 parallel to the outer wall 2. A groove 6 or 7, respectively, is provided at the transition between the flanks 3, 4 and the inner wall 5. The flank 3 and the groove 6, as well as the flank 4 and the groove 7, each form a side wall of the hollow profile rod 1. The outer wall 2 projects beyond the flanks 3, 4 on both sides. The projecting part 8 of the outer wall 2 either can determine the spacing between two glass panels that are to be assembled to an insulating glass pane with a spacer formed from a hollow profile rod 1 fitted between the panels, or can serve to be applied to the edges of the glass panels (FIG. 28). Preferably, the hollow profile rod 1 is made from a plastic material and may be produced as an extruded profile.

At the points of the hollow profile rod 1 where the corner is to be formed a recess 9 is provided in the hollow profile rod 1 that extends from the inner wall 5 to and into the flanks 3 and 4. Provided in the flanks 3 and 4 are two portions 10 of the recess 9, arranged congruently one opposite the other, that have the shape of a rectangular miter cut the point of which is located at the level of the inside of the outer wall 2 and determines the location of the bending axis 12 about which the corner is to be bent. On both sides of the miter cuts in the flanks 3 and 4, the inner wall 5, including the grooves 6 and 7, has been removed over a predefined length and over its full width. The lengths of the portions 11 of the recess 9 in the inner wall 5 preferably are selected to conform one with the other.

FIGS. 30 and 31 show the process of making a first cut (FIG. 30) and a second cut (FIG. 31) in a hollow profile rod 1, as shown in FIG. 1, for producing the recess 9 illustrated in FIG. 1. To this end, the hollow profile rod 1 is initially clamped from the outside in a tool that comprises two clamping jaws 47 that clamp the hollow profile rod 1 between them by its flanks 3 and 4. Each of the clamping jaws is provided with a wedge-shaped recess 48, 49 respectively, provided one opposite the other and corresponding to that portion 10 of the recess that is to be formed in the flanks 3 and 4. A first cutting insert 50 is provided with a cutting edge 52 on one of its edges and with a wedge-shaped cutting profile 53, extending transversely to the cutting edge 52, on its lower face. It can be displaced from a retracted position, in which it is located laterally above the flank 3, along a path that extends at a right angle to the longitudinal extension of the hollow profile rod 1 and that is inclined relative to the inner wall 5 of the hollow profile rod 1. In the course of that displacement, its cutting edge 52 hits upon the inner wall 5, pierces it and then hits upon and cuts through the one side wall of the hollow profile rod 1 at the transition from the groove 7 to the flank 4, against the clamping jaw 47 that serves as an abutment, as illustrated in FIG. 30. The first cutting insert 50 then moves back to its retracted position.

Just as the first cutting insert 50, a second cutting insert 51 is provided with a cutting edge 54 on one of its edges and with a wedge-shaped cutting profile 55 on its lower face. The second cutting insert 51 has a retracted position laterally of the flank 4 and can be moved to and fro along a path that extends transversely to the longitudinal extension of the hollow profile rod 1 and in parallel to the inner wall 5. The two cutting inserts 50 and 51 have the same width, i.e. their cutting edges 52 and 54 have the same length. During its forward movement, the cutting edge 54 of the second cutting insert 51 initially enters the portion of the recess 9 that has been produced by the first cutting insert 50, and enlarges that portion by cutting off the portion of the inner wall 5 that has not been removed by the first cutting operation, whereafter it hits upon and cuts through the side wall of the hollow profile rod 1 at the transition between the groove 6 and the flank 3. Thereafter, the cutting profile 55, being set back relative to the cutting edge 54, hits upon the flank 3 and punches out a wedge-shaped section 10 against the clamping jaw 47 that serves as an abutment, as illustrated in FIG. 31. The second cutting insert 51 is then moved back to its retracted position.

The clamping jaws 47 with their wedge-shaped recesses 48 and 49 therefore serve not only for clamping the hollow profile rod 1, but also as dies for the two cutting inserts 50 and 51. If necessary, the hollow profile rod 1 may be additionally clamped on a support by means of two holding-down clamps that should then be arranged on both sides of the cutting inserts 50 and 51. The support and the holding-down clamps are not shown in the drawing for reasons of clarity. The support supports the outer wall 2 of the hollow profile rod 1, the holding-down clamps act on the inner wall 5 of the hollow profile rod 1 from the opposite side.

Where adequate stability of the side walls of the hollow profile rods 1 is guaranteed, the recess 9 can be formed also using a single cutting insert which is then moved, just as the second cutting insert 51, in parallel to the inner wall 5, piercing the hollow profile rod 1 over its full width.

Alternatively, the recess 9 may also be formed by milling and/or drilling, although the operation is quicker and less expensive if one or two cutting inserts are used.

Chips and other trimmings can be removed by suction.

Prior to bending a right-angle corner in the hollow profile rod 1, a foldable angle piece 13 is fitted in the recess 9—in FIG. 2 it is shown fitted in the hollow profile rod 1—with the angle piece 13 extending a certain distance below the inner wall 5 on both sides of the recess 9—which condition is not visible in FIG. 2.

FIG. 5 shows a side view of the fitted angle piece 13 according to FIG. 2. The angle piece 13 consists of two legs 14 and 15 of equal length that are connected one with the other via a foil hinge 16 provided on the outside of the angle piece 13. The term outside of the angle piece 13 relates to that side which faces the outer wall 2 of the hollow profile rod 1 when the angle piece 13 is fitted in the hollow profile rod 1. The two legs 14 and 15 are provided with flexible ribs 17, directed toward the outer wall 2 of the hollow profile rod, that project a little beyond the foil hinge 16. The inside of the legs 14,15 is flat—except for an inclined lead-in portion 18 at the tips of the legs 14,15—and extends in parallel to the outside of the foil hinge 16 in the straight configuration of the angle piece 13. The height of the legs 14 and 15 is selected and adapted with respect to the clear height of the hollow profile rod 1 in such a way that in its straight configuration the fitted angle piece 13 is in contact with the outer wall 2 by its foil hinge 16 and with the inside of the inner wall 5 by the side of its legs 14 and 15 opposite the foil hinge 16, as illustrated in FIG. 8. Given the fact that the ribs 17 project a little beyond the outside of the foil hinge 16 they are bent off a little in the fitted position of the angle piece 13, with the effect that a tight fit of the legs 14,15 is achieved between the outer wall 2 and the inner wall 5 of the hollow profile rod 1.

On the side of each of the legs 14 and 15 that faces away from the foil hinge 16 there is formed a stop 14a and 15a, respectively, in that the height of the legs 14 and 15 in the neighborhood of the foil hinge 16 is increased in steps by approximately the thickness of the inner wall 5. The stops 14a and 15a face the two edges 19 and 20 that delimit the portions 11 of the recess 9 in the inner wall 5 and that extend from the one flank 3 to the opposite flank 4, transversely to the longitudinal direction of the hollow profile rod 1. The position of the stops 14a and 15a is adjusted to the length of the recess 9 so that the stops 14a and 15a come to lie closely before the edges 19 and 20. This centers the middle of the foil hinge 16 on the specified bending axis 12.

Each of the two legs 14 and 15 is provided, on one half of its width in the neighborhood of the foil hinge 16, with a recess 21 that is open on its side facing the opposite leg 15, 14. On the other half of their width, the legs 14 and 15 are each provided with a hook 22 in the neighborhood of the foil hinge 16. The two hooks 22 face away from each other, namely in the direction of the tips of the legs 14 and 15. The hook 22 of each leg 14,15 is arranged opposite the recess 21 in the other leg 14,15. The configuration and arrangement of the hooks 22 are such that the hooks snap into the oppositely arranged recess 21 when the two legs 14a, 15a are pivoted about the foil hinge 16. Due to their form-locking engagement in the recesses 21, the two legs 14 and 15 are thus positioned and fixed in place at a right angle one relative to the other. Preferably, the design of the foil hinge 16 is such that in the bent condition a restoring force is produced that acts to urge the hooks 22 against the wall of the recess 21 thereby additionally stabilizing the corner.

The angle piece illustrated in FIG. 5 can be fitted in the hollow profile rod 1 in the way illustrated in FIGS. 6 and 7. For this purpose, the angle piece 13 is clamped by its foil hinge 16 between a wedge-shaped abutment 23 and a finger 24. The two legs 14 and 15 are pivoted against the abutment 23 by two further fingers 25 and 26. The tips of the legs 14 and 15 then have been approached one to the other sufficiently for being introduced into the recess 9 (FIG. 6). Now, the abutment 23 is removed and the fingers 24, 25 and 26 are approached to the hollow profile rod 1 in the direction indicated by the three arrows in FIG. 7. As a result, the angle piece 13 is pressed into the hollow profile rod 1, while being simultaneously spread, during which process the legs 14 and 15 are bent temporarily by the fingers 25 and 26 (FIG. 7). Introduction of the angle piece 13 is complete when the angle piece is fitted in the hollow profile rod 1 in straight condition. The sections of the legs 14 and 15 that project beyond the stop 14a and 15a then lie below the inner wall 5, as illustrated in FIG. 8.

Once an angle piece 13 has been inserted in straight condition into each of the recesses 9, for all the four corners of the spacer, the hollow profile rod 1, still occupying its straight configuration, is continuously coated with a sealing compound 27 on the inner wall 5, and with a bonding compound 28, capable of curing, on the flanks 3 and 4. This is effected by moving the hollow profile rod 1 linearly past one or more nozzles from which the sealing compound 27 and the bonding compound 28 can be extruded in a controlled way in synchronism with the movement of the hollow profile rod 1. One way of carrying out that process is described, for example, by DE 10 2004 020 883, to which reference is herewith expressly made. The sealing compound 27 is intended to subsequently prevent diffusion of water vapor into the insulating glass pane in which the spacer formed from the hollow profile rod 1 is to be installed. The sealing compound 27 consists, for example, of a material based on polyisobutylene and preferably contains a drying agent in powder form. The sealing compound 27 covers the entire inner wall 5 and extends laterally beyond the latter so that it even projects beyond the line of the flanks 3 and 4 and fills the grooves 6 and 7 at least in part. The bonding compound. 28, which preferably is a reactive hot-melt, is applied on the flanks 3 and 4 continuously and closely adjacent the sealing compound 27, preferably using nozzles that are operated shortly after the nozzles used for applying the sealing compound 27. This provides the advantage that the sealing compound 27, that has been applied before, serves, as a limiting line for the application of the bonding compound 28 and that application of the sealing compound 27 can be controlled independently of the application of the bonding compound 28, which may be of advantage with respect to sealing compounds having different properties, such as ductility and compressibility.

Once the hollow profile rod 1 has been coated with the sealing compound 27 and the bonding compound 28 (FIG. 3) it can then be bent or folded at the points provided for this purpose, for forming the corners of the frame-like spacer during which process the restoring force provided by the foil hinge has to be overcome. This is illustrated in FIG. 9 by way of an uncoated hollow profile rod 1 in order to show how the hooks 22 engage the recesses 21, thereby fixing the legs 14 and 15 one relative to the other at a right angle. Due to the form-locking engagement of the hook 22 in the associated recess 21, no angle greater than 90 degrees can be formed between the two legs 14 and 15. Once the hooks 22 have snapped into the associated recesses 21, stops acting between the legs 14, 15 will prevent any further reduction in size of the angle. In bending or folding of the corner any excessive amounts of sealing compound 27 and bonding compound 28 are in part pressed into cavities existing in the area of the corner and are in part displaced onto the flanks 3 and 4, as illustrated in FIG. 4. This is desirable because it contributes toward sealing the spacer in the area of the corners. When the spacer is subsequently installed in an insulating glass pane, any excessive amounts of sealing compound 27 and of bonding compound 28 on the flanks 3 and 4 are pressed against the flanks 3 and 4 and into the corner by the glass panels, which once more favors the formation of a hermetically tight corner.

FIG. 10 shows a modified embodiment of the angle piece 13. It differs from the angle piece 13 illustrated in FIG. 5 in that one of the stops 14a, 15b, in the illustrated example the stop 14a, is moved closer to the hooks 22 by such an amount that the spacing from the stop 14a to the tip of the other leg 15 does not exceed the length of the recess 9 in the inner wall 5. This then permits the angle piece 13 to be fitted in the hollow profile rod 1 in the way illustrated in FIGS. 11 to 13. To this end, the foil hinge is slightly bent and the leg 14 is introduced into the hollow profile rod 1 until the stop 14a comes to abut against the edge 19. In that position, the other leg 15 can be pivoted through the recess 9 until it gets in contact with the outer wall 2 (FIG. 12). Thereafter, the angle piece 13 is displaced, in its flat condition, in the hollow profile rod 1 until the stop 15a abuts against the edge 20 of the recess 9 (FIG. 13). Now, the foil hinge 16 is centered on the predefined bending axis 13.

The four successive steps of bending or folding a hollow profile rod 1 to form a frame-shaped spacer is illustrated diagrammatically in FIGS. 15 to 19. In its initial position, the outer wall 2 of the hollow profile rod 1 rests for example on a horizontally extending support 29, for example on a conveyor belt, and leans against a supporting surface 30, coated with a plastic material to which the sealing compound 27 and the bonding compound 28 will not adhere. Plastic materials of that kind are known to the man of the art. Suited as such a material is, for example, a silicon dusted with talc powder. Now, the first leg 1a of the hollow profile rod 1 is pivoted by 90 degrees, while the second leg 1b is retained on the support 29, thereby forming the first corner 31. The second corner 32 is formed by pivoting the second leg 1b by a right angle (FIG. 16) relative to the leg 1c, while the latter is retained in its position. The third corner 33 is formed by pivoting the third leg 1c by 90 degrees relative to the fourth leg 1d, while the latter is retained in its position, and the fourth corner 34 is formed by pivoting the fourth leg 1d by a right angle relative to the fifth leg 1e, retained in its position, or the fifth leg 1e relative to the fourth leg 1d, retained in its position. These steps may of course also be carried out in reverse order. Upon completion of the process, the two ends of the hollow profile rod 1 are positioned one opposite the other (FIG. 18). They are connected by a straight connector 35 one half of which conveniently has been fitted in the one end of the hollow profile rod already after the latter has been cut to length, and the other half of which is now fitted in the other end (FIG. 19). The frame-shaped spacer is now closed and presents an especially stable structure due to its rigid corner configuration. The fifth leg 1e conveniently has the same length of, for example, 10 cm for all spacer formats which is helpful in terms of standardized processes. Once the frame has been closed, the joint between the two ends of the hollow profile rod 1 may be sealed additionally, if necessary, i.e. if the sealing compound 27 and the bonding compound 28 should not adjoin each other tightly in this area, by application of an additional coat of sealing compound 27 and/or a secondary bonding compound 28, for example.

Some ways of achieving a tight joint in the spacer will be described hereafter with reference to FIGS. 32 to 35. The oblique view of FIG. 32 shows the two oppositely arranged ends of the hollow profile rod 1 after bending of all corners for the spacer. A straight connector 35 is fitted in the one end of the hollow profile rod 1 with half of its length projecting beyond the end of the hollow profile rod 1. A stop—not shown—provided in the middle of the connector 35 prevents the connector in the known way from being introduced too far into one of the ends of the hollow profile rod 1. The sealing compound 27 and the bonding compound 28 applied on the flanks 3 and 4 extend over part of the length of the projecting portion of the connector 35, the thickness of the coating preferably decreasing continuously to zero as the distance from the end of the connector 35 increases. In order for that condition to be achieved, coating of the hollow profile rod with the sealing compound 27 and the bonding compound 28 conveniently starts on the connector 35. One thereby almost automatically achieves a gradual increase in thickness of the coating as the coating operation will hardly commence by a sudden step, for reasons of continuity. If necessary, the contour of the coating on the connector 35 may be altered subsequently, for example by trimming using a heated wire, so that the tapering contour illustrated in FIG. 32 will be obtained. Any excessive amount of sealing compound 27 and of bonding compound 28, that may be removed by the trimming operation, can be removed by suction. At the opposite end of the hollow profile rod 1, where the coating operation ended, the end of the coating of the sealing compound 27 and the bonding compound 28 may likewise be trimmed, for example using a heated wire, so that preferably a plain end face is obtained, as illustrated in FIG. 32. The plain end face preferably ends flush with the end face of the hollow profile rod 1, or projects a little beyond the end face of the hollow profile rod 1, as shown in exaggerated size in FIG. 30.

As the projecting portion of the connector 35 is introduced into the opposite end of the hollow profile rod 1, the tapering section of the sealing compound 27 and the bonding compound 28 of the connector 35 enters the space below the sealing compound 27 and the bonding compound 28, projecting beyond the opposite end of the hollow profile rod 1, thereby expanding the projecting section of the compound. Further, the sealing compound 27 and the bonding compound 28 applied on the connector 35 abut against the opposite end face of the hollow profile rod 1. Both these conditions cause the sealing compound 27 and the bonding compound 28 to be compressed in the area of the joint of the spacer, and to interlink one with the other, as illustrated in FIG. 33.

In order to permit the spacer to be closed with the aid of the connector 35, the projecting parts 8 of the outer wall 2 of the hollow profile rod 1 may be gripped between two tongues of variable spacing so as to approach the two ends of the hollow profile rod one to the other. The compressed joint in the sealing compound 27 and the bonding compound 28, illustrated in FIG. 33, can then be egalized in a subsequent step. This can be done using a form tool 56 of the kind shown in FIG. 34, by way of example. The form tool 56 comprises two jaws 57 and 58 that are variable in spacing and the inside of which is adapted to the contour envisaged for the sealing compound 27 and the bonding compound 28. The form tool 56 initially embraces the joint in the spacer, with the jaws 57 and 58 being still open, and is then gradually closed to the required width, during which operation the form tool 56 may be moved in the longitudinal direction of the hollow profile rod 1, preferably by a reciprocating movement. Finally, the form tool 56 is opened and removed.

It should be noted in addition that for closing the spacer such a form tool may also be employed for approaching one end of the coated hollow profile rod 1 to the opposite, fixed end of the hollow profile rod 1. Due to the large-area contact with the coating consisting of the sealing compound 27 and the bonding compound 28, sufficient force can be transmitted for fitting the connector 35 in the remaining open end of the hollow profile rod 1, without any disadvantage for the coating (FIG. 32).

An alternative process of producing a tight joint in the spacer provides that instead of coating the connector 35 with sealing and bonding compound, coating is effected in such a way that initially a gap is left in the coating of sealing compound 27 and bonding compound 28, at the joint of the spacer. That gap can then be closed later by embracing the sealing compound 27 and the bonding compound 28 present in the neighborhood of the gap by a nozzle 59 that has an inner side the contour of which is adapted to the contour of the coating of sealing compound 27 and bonding compound 28 (FIG. 35). The width of the nozzle 35 is adjustable for that purpose, for example by two jaws 57 and 58 provided in the nozzle 59, which are slidably supported on the nozzle body so as to permit their mutual spacing to be varied, and the design of which conforms to one half each of the contour envisaged for the coating of the sealing compound 27 and the bonding compound 28. Once the joint has been enclosed by the nozzle 59, the gap in the coating can be closed by injecting sealing compound 27. Injecting additional bonding compound 28 at this point is possible, but not required. By displacing the nozzle 59 in the longitudinal direction of the hollow profile rod 1, the joint can then be smoothed, whereafter the nozzle 59 can be opened and removed. The structure of the form tool 56 (FIG. 34) resembles that of the nozzle 59, with the exception that the form tool 56 does not have a channel 60 for the supply of sealing compound and that only one of its jaws 57, 58 can be displaced.

The inner structure of a frame-shaped spacer with angle pieces 13 of the kind illustrated in FIGS. 10 to 14, is illustrated in FIG. 20 where the coating of a sealing compound 27 and a bonding compound 28 is not shown for reasons of clarity.

A spacer formed from a hollow profile rod 1, where the inner wall 5 is coated with a sealing compound 27, as illustrated for example in FIG. 21, is particularly well suited for installation of one or more muntins 36. This is effected by pressing a foot piece 37 into the sealing compound 27, without however piercing the layer of sealing compound 27 present on the inner wall 5, so that a full-surface coating is maintained on the inner wall 5, which is an advantage with respect to the sealing of the insulating glass pane from diffusion of water vapor. As the foot piece 37 is pressed into the compound a corresponding quantity of sealing compound 27 is displaced, rising along its edges, so that an interlocking effect is obtained between the sealing compound 27 and the foot effect is obtained between the sealing compound 27 and the foot piece 37. As sealing compounds such as polyisobutylene are sticky, the desirable adhesive effect is added to the interlocking effect between the sealing compound 27 and the foot piece 37. The interlocking effect between the sealing compound 27 and the foot piece 37 is especially efficient when the foot piece 37 comprises a plate 38 provided with passages 39, as illustrated in FIG. 24. In that case, the sealing compound 27 is also displaced into the passages 39, whereby an especially intimate interlocking with the foot piece 37 is obtained. Mounted on the plate 38 is a connection means 40 in the form of a two-legged fork with barbs 41 directed in opposite directions. The fork 40 can be snapped into a matching receiving element 42 fitted in the end of the hollow muntin 36. The receiving element 42 may be a molded plastic part which has an outer contour adapted to the inner contour of the muntin 36 and which is provided with ribs 43 which are bent off toward the end of the muntin 36, as the receiving element 42 is introduced into the muntin 36, and which therefore oppose increased resistance to an attempt to pull off the muntin 36. The inner contour of the receiving element 42 is the same for all kinds of muntins 36. This provides the advantage that one and the same foot piece 37 will be suited for all sorts of muntins 36, which may differ in cross-section.

The receiving element 42 is provided with an undercut 44 that can be resiliently engaged by the barbs 41.

During the process of coating the straight hollow profile rod 1 by a continuous process the coating may be marked at the points where a muntin 36 is to be located, for example using an ink jet printer. The foot piece 37 can then be pressed into the sealing compound 27 manually at the points so marked. Alternatively, the foot pieces 37 can be placed automatically using a numerically controlled handling device; in that case, it is not necessary to mark the points where the foot pieces 37 are to be placed later. For example, the muntins 36 can be fitted on the foot pieces 37 shortly before the spacer is finally closed (FIG. 18)—see FIGS. 25 and 26.

FIG. 28 shows a cross-section through part of an insulating glass pane consisting of two separate glass panels 45 and 46 which enclose between them a frame-shaped spacer formed from a hollow profile rod 1—as illustrated in FIG. 21—that has been coated before with a sealing compound 27 and a curable secondary sealing compound 28. The hollow profile rod 1 is aligned flush with the edges of the glass panels 45 and 46, with the projecting parts 8 of the outer wall 2 covering the edges of the glass panels 45 and 46 in intimate contact with the latter so as to protect them from splintering.

The insulating glass pane illustrated in FIG. 29 differs from the insulating glass pane illustrated in FIG. 28 in that the projecting parts 8 of the outer wall 2 of the hollow profile rod 1 do not serve to protect the edges of the two glass panels 45 and 46. Instead, the projecting parts 8 of the outer wall 2 are positioned between the two glass panels 45 and 46 thereby defining the spacing and the minimum thickness of the coating on the flanks 3 and 4 of the hollow profile rod 1. The outer wall 2 of the hollow profile rod 1 is aligned flush with the edges of the glass panels 45 and 46 so that no marginal gap remains between the panels that would have to be sealed later.

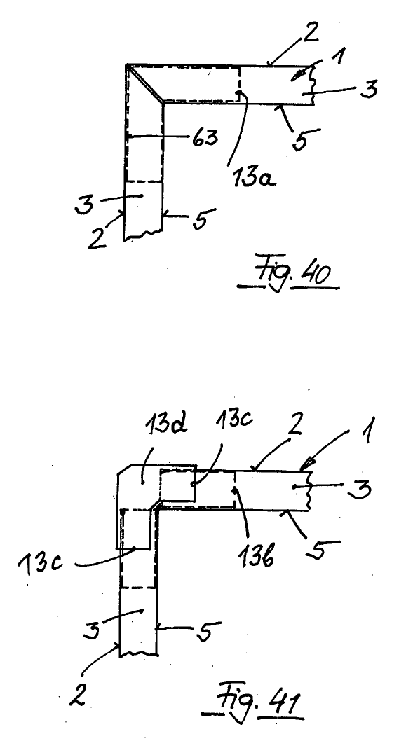

FIGS. 36 to 39 show processes of folding the hollow profile rod 1, that are modified relative to that illustrated in FIGS. 15 to 19. A substantial difference, compared with the process illustrated in FIGS. 15 to 19, is seen in the fact that the hollow profile rod 1 is not displaced in longitudinal direction, but remains in its position on the support 29 during folding or bending of the four corners 31 to 34. For this purpose, the hollow profile rod 1 is retained in its position, in an area beside the first bending point where the first corner 31 is to be formed, for example by pressing the second leg 1b of the hollow profile rod 1 against the support 29 using a holding-down clamp not shown, or by clamping the projecting portions 8 of the outer wall 2 of the second leg 1b by tongues not shown in the drawing. For forming the first corner 31, one initially bends off the first leg 1a. This can be done manually. Preferably, the length X of the first leg 1a is selected to be equal for all spacer formats, for example between 6 cm and 10 cm. This provides the advantage that the spacer will always be closed at the same point where the tools required for closing or, if necessary, for reworking and smoothing of the hollow profile rod 1, may then be located (FIGS. 34 and 35). Next, the operator may grip the fixed leg 1e and bend it off for forming the fourth corner 34. The operator may then pick up the fourth leg 1d and bend it off to form the third corner 33. Finally, the operator may pick up the third leg 1c and bend it off to form the second corner 32. An even more elegant and simple process is obtained when the fifth leg 1e is picked up by the operator and guided in one step along a bent path to the connector 35; during that operation, the second corner 32, the third corner 33 and the fourth corner 34 are permitted to form freely at the same time. The process of closing the spacer ends by fitting the fifth leg 1e on the connector 35 already present in the fixed leg 1e (FIG. 39). During bending or folding of the corners 31 to 34 of the spacer, its legs 1c, 1d and 1e may be moved along a supporting surface 30, which is shown in FIGS. 36 to 39 to extend in parallel to the drawing plane and which is covered by a coating to which the sealing compound 27 and the bonding compound 28 will not adhere.

A guiding arrangement 61, for example a metal sheet projecting beyond the supporting surface 30 in flush arrangement with the outer wall 2 of the first leg 1a, may be provided on the supporting wall in the area of the joint 62, for making it easier for the operator to align the fifth leg 1e with the first leg 1a.

Insulating glass panes having a plurality of corners are correspondingly provided with a spacer having the same plurality of corners. According to a preferred arrangement, an angle piece with two legs connected by a hinge is provided at each corner of the spacer, and the beginning and the end of the hollow profile rod forming the spacer are to be joined between two corners and to be connected by a straight connector. However, it would also be possible, for a spacer having a plurality of corners, to have the ends of the hollow profile rod forming the spacer end in the area of a corner where they are then connected by an angle piece. Two examples of such a corner configuration are illustrated in FIGS. 40 and 41. In the example of FIG. 40, the ends of the hollow profile rod 1 are cut off at an angle of 45 degrees so that they join each other at that angle, being in contact over their full circumference. The corner is then held together and stabilized by insertion of an angle piece 13a of, preferably, U-shaped cross-section, and this especially when the base of the U-section forms the outside 63 of the angle piece 13a.

The embodiment illustrated in FIG. 41 differs from that shown in FIG. 40 in that the two ends of the hollow profile rod 1 are cut off flush and get into contact with each other only by the edge of the inner wall 5 of the hollow profile rod 1. In that case, the angle piece 13b conveniently consists of a solid molded plastic part the two legs of which are fitted in the two ends of the hollow profile rod 1 by a frictional fit, the two legs of the angle piece 13b being connected by a solid body 13d that fills the angle between the ends of the hollow profile rod 1, with a thin-walled hood-like cover 13c extending from the body, which has a U-shaped cross-section and which covers the outer wall 2 and the two flanks 3 and 4 of the hollow profile rod 1 over a certain length.

In the embodiments shown in FIG. 40 and FIG. 41, it is advisable to seal the gap existing in the area of the corner by application of a sealing compound. Because of that sealing requirement, the embodiments according to FIG. 40 and FIG. 41 are not preferred.

### List of Reference Numerals:

1. Hollow profile rod
1a. First leg
1b. Second leg
1c. Third leg
1d. Fourth leg
1e. Fifth leg
2. Outer wall
3. Flank
4. Flank
5. Inner wall
6. Groove
7. Groove
8. Projecting part of 2
9. Recess
10. Portions of the recess in 3,4
11. Portions of the recess in 5
12. Bending axis
13, 13a, 13b Angle piece
13c. Thin-walled cover
13d. Body
14. Leg of 13
14a. Stop
15. Leg of 13
15a. Stop
16. Foil hinge
17. Ribs
18. Inclined lead-in portion
19. Edge
20. Edge
21. Recess
22. Hook
23. Abutment
24. Finger
25. Finger
26. Finger
27. Sealing compound
28. Bonding compound; secondary sealing and bonding compound
29. Support
30. Supporting surface
31. First corner
32. Second corner
33. Third corner
34. Fourth corner
35. Straight connector
36. Muntin
37. Foot piece
38. Plate
39. Passages in 38
40. Connection means
41. Barbs
42. Receiving element
43. Ribs
44. Undercut
45. Glass panel
46. Glass panel
47. Clamping jaws
48. Wedge-shaped recess
49. Wedge-shaped recess
50. First cutting insert
51. Second cutting insert
52. Cutting edge
53. Cutting profile
54. Cutting edge
55. Cutting profile
56. Form tool
57. Jaw
58. Jaw
59. Nozzle
60. Channel
61. Guide arrangement
62. Joint
63. Outside of 13a

1. Insulating glass pane in which two separate glass panels are held at a distance one from another by a frame-shaped spacer formed from a hollow profile rod or from hollow profile rods which are connected in a linear manner, the spacer having an outer wall, two flanks, and an inner wall,
comprising at least one corner at which the hollow profile rod is provided with a recess each that starts out from the inner wall and extends into the flanks, in the direction of the outer wall, without opening the outer wall, wherein a prefabricated angle piece is placed in the hollow profile rod at the at least one corner of the spacer, which comprises two legs connected by a hinge that are fixed in relation to each other in a position in which they enclose between them a predefined angle.

2. The insulating glass pane as defined in claim 1, wherein the two legs of the angle piece are locked one relative to the other in their position in which they enclose between them the predefined angle.

3. The insulating glass pane as defined in claim 1, wherein the two legs of the angle piece are snap-fastened one relative to the other in their position in which they enclose between them the predefined angle.

4. The insulating glass pane as defined in claim 1, wherein the two legs of the angle piece are in form-fitting engagement one with the other in their position in which they enclose between them the predefined angle.

5. The insulating glass pane as defined in claim 1, wherein a recess is provided in one leg of the angle piece, with a projection, especially a hook, provided on the other leg of the angle piece, opposite the recess, which engages the recess when the two legs enclose between them the predefined angle.

6. The insulating glass pane as defined in claim 5, wherein both a projection and a recess are provided on each of the two legs, for reciprocally engaging each other.

7. The insulating glass pane as defined in claim 1, wherein the two legs of the angle piece are connected one with the other to form a single piece.

8. The insulating glass pane as defined in claim 1, wherein the hinge is configured in the way of a foil hinge.

9. The insulating glass pane as defined in claim 1, wherein the angle piece has an outside that faces the outer wall of the hollow profile rod and that the hinge is arranged on the outside of the angle piece.

10. The insulating glass pane as defined in claim 1, wherein the hinge rests against the inner side of the outer wall of the hollow profile rod.

11. The insulating glass pane as defined in claim 1, wherein the angle piece is a molded plastic part.

12. The insulating glass pane as defined in claim 1, wherein it comprises angle pieces the legs of which can be pivoted from a straight configuration not only into the position in which they enclose between them the predefined angle and in which they can be fixed one relative to the other, but also in the opposite direction.

13. The insulating glass pane as defined in claim 1, wherein the recesses provided in the hollow profile rod extend up to the outer wall.

14. The insulating glass pane as defined in claim 1, wherein the recesses in the hollow profile rod are provided with edges that extend in the flanks in a way that ensures that, once the comers have been formed, the edges abut each other in the flanks in pairs, or leave merely a narrow gap between them.

15. The insulating glass pane as defined in claim 1, wherein viewed from the angle point of the respective corner, the portions of the respective recess, that extend in the inner wall of the hollow profile rod, extend beyond the edge of the corresponding portion of the recess in the flanks, but not up to the free end of the legs of the angle piece located in that area.

16. The insulating glass pane as defined in claim 1, wherein the legs of the angle piece have a stop which is directed against the edge of the recess in the inner wall that extends from the one flank to the other flank.

17. The insulating glass pane as defined in claim 1, wherein its inner wall of the spacer is coated with a sealing compound without any interruption on its side facing the inner space of the insulating glass pane.

18. The insulating glass pane as defined in claim 17, wherein the sealing compound contains a drying agent.

19. The insulating glass pane as defined in claim 17, wherein the sealing compound extends from the one flank to the other flank.

20. The insulating glass pane as defined in claim 17, wherein the sealing compound is or contains a polylsobutylene.

21. The insulating glass pane as defined in claim 1, wherein a secondary sealing or bonding compound is applied on the flanks.

22. The insulating glass pane as defined in claim 21, wherein the secondary sealing or bonding compound is a curable compound.

23. The insulating glass pane as defined in claim 21, wherein the secondary sealing or bonding compound is a hot-melt bonding compound, especially a reactive hot-melt compound.

24. The insulating glass pane as defined in claim 19, wherein the sealing compound applied on the inner wall of the spacer adjoins the secondary sealing or bonding compound applied on the flanks without any gaps.

25. The insulating glass pane as defined in claim 17, wherein one or more muntins are fitted in the spacer, which are anchored on or in the sealing compound indirectly or directly by separate foot pieces.

26. The insulating glass pane as defined in claim 25, wherein the muntins and/or their foot pieces are anchored on or in the sealing compound without piercing it fully to the inner wall.

27. The insulating glass pane as defined in claim 26, wherein the foot pieces comprise a plate and a connection means projecting from the latter, that engages in a receiving element fitted in the hollow muntin.

28. The insulating glass pane as defined in claim 27, wherein the plate comprises recesses and/or passages that accommodate any displaced sealing compound.

29. The insulating glass pane as defined in claim 1, wherein the predefined angle at which the legs of the angle piece are fixed one to the other is a right angle.

30. The insulating glass pane as defined in claim 1, wherein a sealing compound that seals the gap is provided between the flanks of the spacer and the two glass panels .

31. The insulating glass pane as defined in claim 30, wherein the sealing compound, that has been applied on the inner wall of the spacer, simultaneously forms the sealing compound in the gap between the flanks of the spacer and the two glass panels.

32. The insulating glass pane as defined in claim 31, wherein the sealing compound present in the gap between the flanks of the spacer and the two glass panels does not contain any drying agent or less drying agent than the sealing compound applied on the inner wall of the spacer.

33. The insulating glass pane as defined in claim 1, wherein the sealing compound is interlocked with the spacer by a form-fit.

34. The insulating glass pane as defined in claim 33, wherein the form-fit between the sealing compound and the spacer exists at least at the transition from the inner wall to the flanks of the spacer.

35. The insulating glass pane as defined in claim 33, wherein for realizing the form-fit the hollow profile rod is provided with an undercut over its full length.

36. The insulating glass pane as defined in claim 35, wherein the form-fit between the spacer and the sealing compound is designed in the form of a dovetail connection.

37. The insulating glass pane as defined in claim 1, wherein the sealing or bonding compound, that provides a durable and stable bond between the glass panels, is provided in the form of two separate ropes, one of them connecting the one glass panel and the other one connecting the other glass panel with the spacer.

38. The insulating glass pane as defined in claim 37, wherein the sealing or bonding compound, that produces the durable and stable bond between the glass panels, is provided only in the gap between the flanks of the spacer and the respective glass panel facing them.

39. The insulating glass pane as defined in claim 1, wherein the spacer ends flush with the edge of the glass panels.

40. The insulating glass pane as defined in claim 1, wherein the hollow profile rod is made from a plastic material.

41. The insulating glass pane as defined in claim 1, wherein the hollow profile rod has a rectangular cross-section.

42. The insulating glass pane as defined in claim 1, wherein the width of the hollow profile rod is greater than its height.

43. The insulating glass pane as defined in claim 1, wherein the outer wall of the spacer comprises projecting portions on both sides of the flanks of the spacer, which cover the edge of the two glass panels.

44. The insulating glass pane as defined in claim 43, wherein the sealing or bonding compound, that produces the firm bond between the spacer and the glass panels, extends into the area between the projecting portions of the outer wall of the spacer and the edge of the glass panels.

45. The insulating glass pane as defined in claim 1, wherein an angle piece, having two legs connected by a hinge, is provided in each of the corners of the spacer.
